(19) United States
(12) Patent Application Publication
(10) Pub. No.: US 2026/0165827 A1
(43) Pub. Date: Jun. 18, 2026

(54) CHEMICAL DELIVERY DEVICE

(71) Applicant: JVD, INC., Scotts Valley, CA (US)

(72) Inventors: Michael L. VANDIERENDONCK, Scotts Valley, CA (US); Ronald POWERS, Ben Lomond, CA (US)

(21) Appl. No.: 19/416,562

(22) Filed: Dec. 11, 2025

Related U.S. Application Data
(60) Provisional application No. 63/733,801, filed on Dec. 13, 2024.

(51) Int. Cl. A61D 7/00

(52) U.S. Cl. CPC A61D 7/00

(57) ABSTRACT

Embodiments of the present disclosure generally relate to devices for controlled release of chemicals. In one embodiment, an apparatus is provided including a casing body having a first body end and a second body end, one or more chambers disposed within a portion of the casing body at a first body end, each of the one or more chambers having a first chamber end disposed in the first body end and a second chamber end comprising a driver recess, a stopper disposed at each of the first chamber end of the one or more chambers, and an ejection device assembly disposed in the casing body in the second body end and at the second chamber end of the one or more chambers, wherein each stopper being ejectable under force using the ejection device assembly.

### CROSS-REFERENCE TO RELATED APPLICATION

This application claims priority to and the benefit of U.S. Provisional Patent Application No. 63/733,801 , filed Dec. 13, 2024, which is incorporated by reference herein in its entirety.

### BACKGROUND

### Field

Embodiments of the present disclosure generally relate to devices for controlled release of chemicals, in particular, for controlled release of a supplement or a medicine and/or storage of animal management information.

### Description of Related Art

A large number of grazing species of animals, including cattle, sheep, goats and deer are classified as ruminant animals. Such animals possess four stomach chambers as part of their digestive system. These animals rely largely on the digestion of grass and other native vegetation for nutrients and sustenance. However, there are large tracts of grasslands throughout the world that are deficient in one or more of the mineral elements required by grazing animals.

A convenient way of supplying these animals with minerals, vitamins or other dietary or medicinal needs is by means of a bolus. A bolus is an object containing and releasing the required supplement or medicine at the required rate to improve or maintain the health of the animal. Such a device is administered to the animal by mouth and lodges naturally (by means of being sufficiently dense or by being fitted with tags or wings which deploy after administration) in either of the first two stomach chambers of the subject animal. Thereafter, the supplement or medicament is released over a period of time influenced by the size, shape and constituent ingredients of the bolus. Many different bolus designs have been utilized to satisfy the particular needs of animals, especially sheep and cattle under different grazing conditions.

The use of boluses in the treatment of ruminants is well known in the veterinary field. Such products are often weighted by a heavy density substance, such as iron or sand, in order to remain in the rumen to release a medicament. If sustained release coatings are present, the release is gradual until the source of medicine is exhausted.

However, prior bolus devices are costly to manufacture. Another limitation of prior bolus designs is that they can only hold about 3 mL/cc per dose chamber for a three chamber device which limits the types of active ingredients that can be dispensed therefrom. The pharmaceutical partners would have needed to get new FDA approvals for highly concentrated active ingredients in order to dispense their active ingredient in prior bolus devices. It is a very costly and long process for pharmaceutical companies to get any type of new animal drug approval for their active ingredients including change of concentrations of active ingredients.

Thus, there is a need in the art for improved delivery devices.

### SUMMARY

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

Embodiments of the present disclosure generally relate to devices for controlled release of chemicals, in particular, for controlled release of a supplement or a medicine and/or storage of animal management information.

In one embodiment, an apparatus is provided including a casing body having a first body end and a second body end, one or more chambers disposed within a portion of the casing body at a first body end, each of the one or more chambers having a first chamber end disposed in the first body end and a second chamber end comprising a driver recess, a stopper disposed at each of the first chamber end of the one or more chambers, and an ejection device assembly disposed in the casing body in the second body end and at the second chamber end of the one or more chambers, wherein each stopper being ejectable under force using the ejection device assembly.

In one embodiment, a method for operating an apparatus including providing a device comprising a casing body, one or more chambers disposed within a portion of the casing body at a first body end, a stopper mounted on each of the one or more the one or more chambers, and an ejection device assembly comprising a compressed spring, a clamping ring disposed around the compressed spring, and a heating element holding close the clamping ring, applying a power to the heating element and releasing the clamping ring, decompressing the spring, moving one of the one or more chambers with the spring, and ejecting the stopper from the first end of the one of the one or more chambers.

In one embodiment, a ruminant bolus delivery device is provided including a cylindrical body and one or more chambers within the cylindrical body, each of the one or more chambers containing a stopper at an end thereof, the stopper being ejectable under force using a spring assembly.

### BRIEF DESCRIPTION OF THE DRAWINGS

So that the way the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIGS. 1A-1C are side, back end, and front-end views of a device according to certain embodiments;

FIG. 2 is a sectional view along of the device along Line A-A of FIG. 1B according to certain embodiments;

FIG. 3 is an isomeric view of the device with a transparent cylindrical body according to certain embodiments;

FIGS. 4A and 4B are side and back end illustrating stopper separation according to certain embodiments;

FIG. 5 is a sectional view along of the device along Line A-A of FIG. 4B according to certain embodiments;

FIGS. 6A and 6B are detailed portion view of Sections B and C of FIG. 5, according to certain embodiments;

FIG. 7 is an exploded side view of the device according to certain embodiments;

FIG. 8A is an exploded isometric view of the device according to certain embodiments;

FIG. 8B is a top down view of a spring assembly according to certain embodiments; and

FIG. 9 is another exploded isometric view of the device according to certain embodiments.

To facilitate understanding, identical reference numerals have been used, where possible, to designate identical elements that are common to the figure. It is contemplated that elements and features of one embodiment may be beneficially incorporated in other embodiments without further recitation.

### DETAILED DESCRIPTION

Embodiments of the present disclosure generally relate to devices for controlled release of chemicals. More specifically, embodiments of the present disclosure relate to devices for controlled release of a supplement or a medicine and/or storage of animal management information. Certain details are set forth in the following description and figures to provide a thorough understanding of various implementations of the disclosure. Other details describing well-known methods and systems often associated with the deposition of material layers are not set forth in the following disclosure to avoid unnecessarily obscuring the description of the various implementations.

Many of the details, components and other features described herein are merely illustrative of particular implementations. Accordingly, other implementations can have other details, components, and features without departing from the spirit or scope of the present disclosure. In addition, further implementations of the disclosure can be practiced without several of the details described below.

Some embodiments of the present disclosure relate to improved ruminant bolus delivery devices. Some embodiments of the present disclosure include ruminant bolus delivery devices in which the end stoppers may be ejected, which may also eject or disperse chemical materials contained in the device.

It is believed that embodiments of the present disclosure beneficially provide: the ability to load about 3 or 4 times the volume of medication, much lower cost to manufacture (about 25% of the cost of the previous version) and much easier to manufacture/assemble and is designed for automated, volume assembly. In addition, embodiments of the present disclosure have about 10 times the amount of stopper ejection force compared to the prior devices making embodiments of the present disclosure far better suited to eject a stopper in a fluid environment.

In some embodiments of the present disclosure a heating element, such as a nichrome wire, clamping ring, and spring assembly are provided, which may be used to hold a loaded spring in place and to release the loaded spring to eject a stopper.

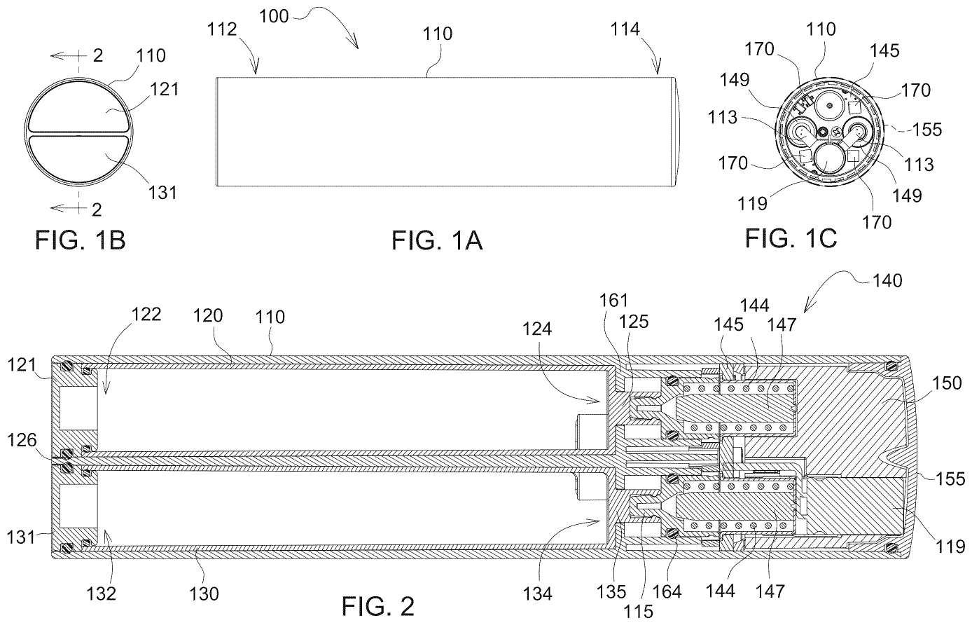

An exemplary embodiment is shown in reference to FIGS. 1-9 using two chambers, however, it is contemplated that different number of chambers may be used, and following description is provided for illustrative purposes.

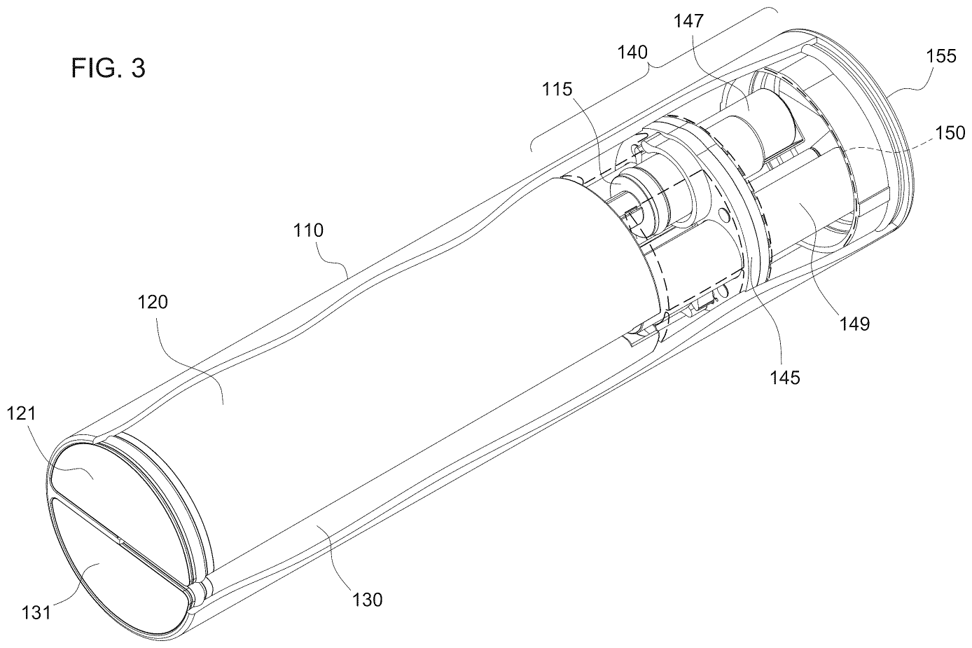

Referring to FIGS. 1A-1C, 2, and 3, one embodiment of the of the device will be described. FIGS. 1A-1C are side, back end, and front end views of a device 100 according to certain embodiments. FIG. 2 is a sectional view along of the device along Line A-A of FIG. 1B. FIG. 3 is an isomeric view of the device with a transparent cylindrical body.

The device 100 includes a casing body 110, one or more chambers, such as first chamber 120 and second chamber 130, one or more stoppers, such as stoppers 121 and 131, and an ejection device assembly. When assembled the device 100 is sealed from fluids, such as air and water. In one embodiment, the sealed device may be considered waterproof. While removal of one of the stopper may result in a fluid entering a chamber, the remaining device is sealed from fluids. The sealed devices allow the devices to be used in liquid environments for extended periods of time.

The casing body 110 has a first body end 112 and a second body end 114. The casing body 110 may be in the form of a cylinder or tube. Alternatively, the casing body 110 may be in the form of other geometric shapes as needs for application purposes, such as cones, cubes, cuboids, among others. The casing body 110 may be made of a water-resistant and/or corrosion resistant material. Suitable casing body 110 materials may be selected from the group of plastic, metal, or combinations thereof. If the casing body 110 material is plastic, the casing body 110 may be made of a transparent or translucent material.

The casing body 110 may optionally include a casing body support 161. The casing body support 161 is disposed on an inner circumference of the casing body 110 and may be located between the chambers 120, 130 and an ejection device assembly 140. The casing body support 161 is used for aligning the components of the system as well as used with the chamber separator 126 for aligning the chambers 120, 130 with the ejection device assembly 140.

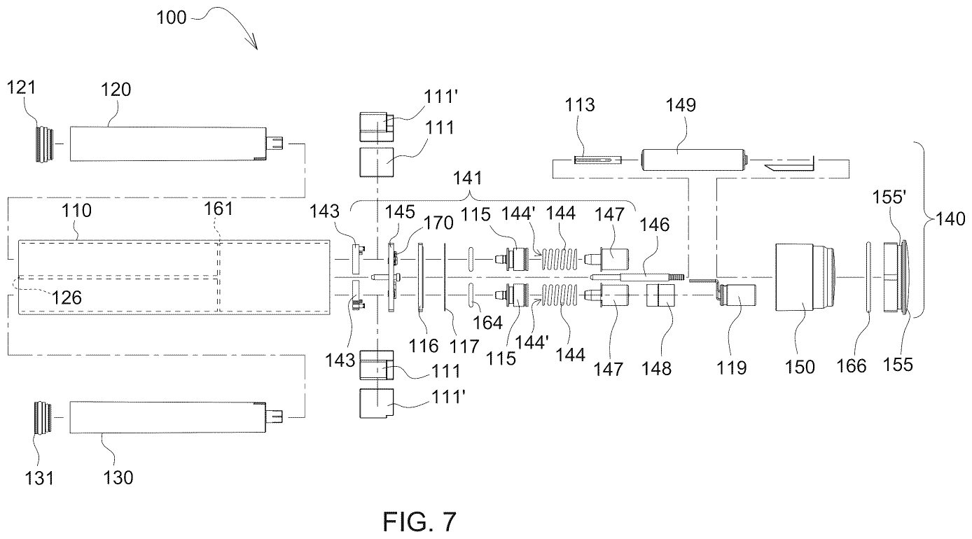

Ejection device assembly spacers may be disposed in the casing for aligning and supporting the chambers 120, 130 with the ejection device assembly 140. Referring to FIGS. 7-9, the device 100 may further include weights to provide desired buoyancy in fluid, such as water or animal organs, such as stomachs. The weights may also prevent premature removal if used in animals, for example rumen retention. Weights may be used as upper weights 111 and lower weights 111′ are shown. The weights may be made from any suitable material, such as metals, that provide a desired weight for the device 100. Alternatively, if plastic or other light weight material is used instead of weights, a device 100 may instead have upper ejection device assembly spacers 111 and lower ejection device assembly spacers 111′ are shown.

Also, referring to FIGS. 7-9A, the casing body support 161 may be adapted to be a component receiving holder. Upper weights 111 and lower weights 111″ may also be adapted with the casing body support 161 for receiving and supporting components of the ejection device assembly 140. The casing body support 161 may be adapted to align with the shaped holder 150 or be adapted to interconnect with the shaped holder 150. The casing body support 161 may be a metal or plastic, and may be the same material as the shaped holder 150.

Embodiments of the present disclosure may include one chamber or a plurality of chambers disposed within a portion of the casing body 110, for example, two chambers or three chambers.

As shown in FIGS. FIGS. 1A-1C, 2, 3, and 4B, a first chamber 120 and a second chamber 130, are disposed in the casing body 110 in a parallel manner with a first chamber end 122 disposed toward or at first body end 112 of the casing body 110. The chambers 120, 130, may be in the shape of a semicylinder for a cylinder or tube shaped casing body 110. The chambers may be of any geometric shape needed to be positioned inside the shape of the casing body 110. The chambers may be hollow chambers or may have shaped interiors. The chambers are configured to hold chemical materials, such as supplements or medicines.

The chambers may be separated by a chamber separator 126 disposed between the chambers. The chamber separator 126 may be used for aligning the chambers with the ejection device assembly as well as providing support during use. The chamber separator 126 may comprise part of the casing body support 161.

Each chamber includes a first chamber end and a second chamber end. The first chamber end comprises a partial or full opening, and a stopper may be disposed in and sealing the opening. The second chamber end is disposed towards an ejection device assembly. The second chamber end comprises a driver recess to receive a driver from the ejection device assembly.

As shown in FIG. 2, the first chamber 120 includes a first chamber end 122 and a second chamber end 124. The first chamber end 122 comprises a partial or full opening 123, and a stopper 121 may be disposed in and sealing the opening 123. The stoppers are disposed in a manner with each stopper being ejectable under force using the ejection device assembly 140. Once a stopper is removed or ejected from a chamber, any chemical material disposed in the chamber may be dispersed or ejected into the surrounding environment.

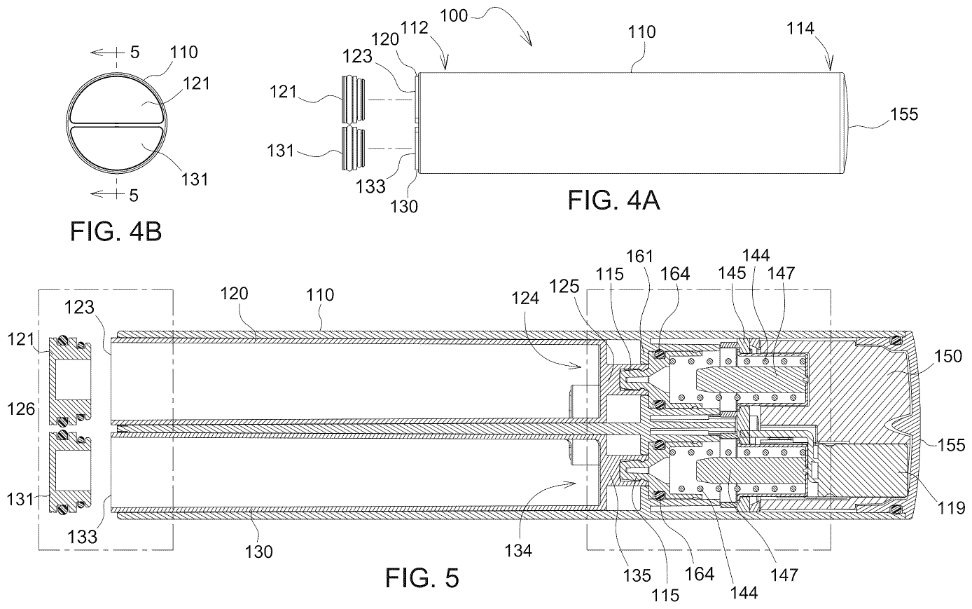

FIGS. 4A, 5, and 6A illustrate the device with stoppers 121 and 131 not disposed in the respective chambers 120, 130. As shown in the figures, the stoppers 121, 131, may further include one or more o-rings, for example o-rings 121′, 121″, 131′, and 131″, for forming a seal with the respective chambers.

The second chamber end 124 is disposed towards an ejection device assembly 140. The second chamber end 124 comprises a driver recess 125 to receive a driver 115 from the ejection device assembly. The second chamber 130 includes a first chamber end 132 and a second chamber end 134. The first chamber end 132 comprises a partial or full opening 133, and a stopper 131 may be disposed in and sealing the opening 133. The second chamber end 134 is disposed towards an ejection device assembly 140. The second chamber end 134 comprises a driver recess 135 to receive a driver 115 from the ejection device assembly. A driver o-ring 164 may be used to help prevent fluids from entering the driver section and ejection device assembly 140, including electrical components, and may also secure the driver 115 in the ejection device assembly 140.

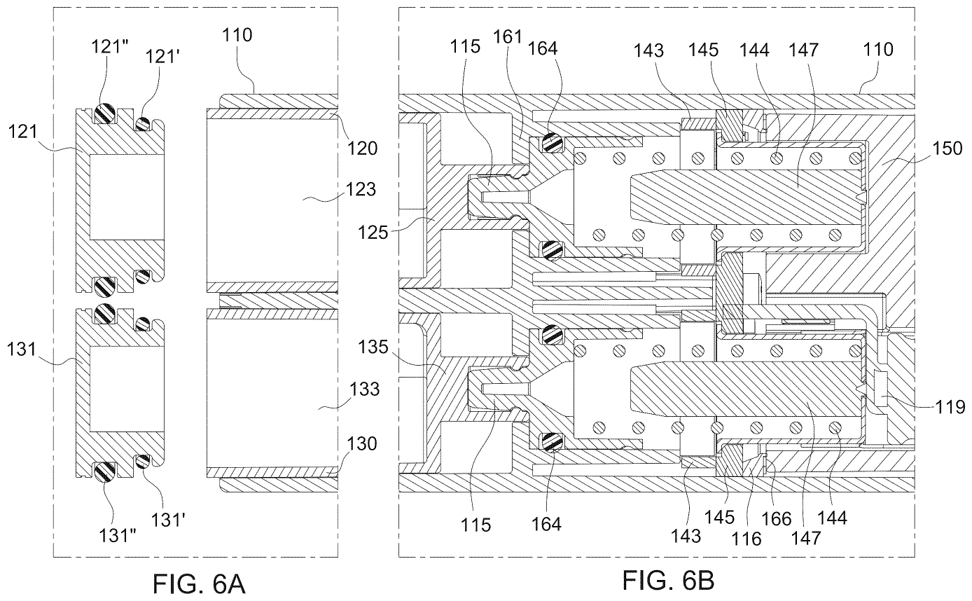

Referring to FIGS. 6B, 7, 8A-8B, and 9, the ejection device assembly 140 is disposed in the casing body 110 in or towards the second body end 114 at the second chamber ends of the one or more chambers.

The ejection device assembly includes an electronic assembly 145, a spring assembly 141 disposed through the electronic assembly 145, and at least one power source 149 coupled to the spring assembly 141.

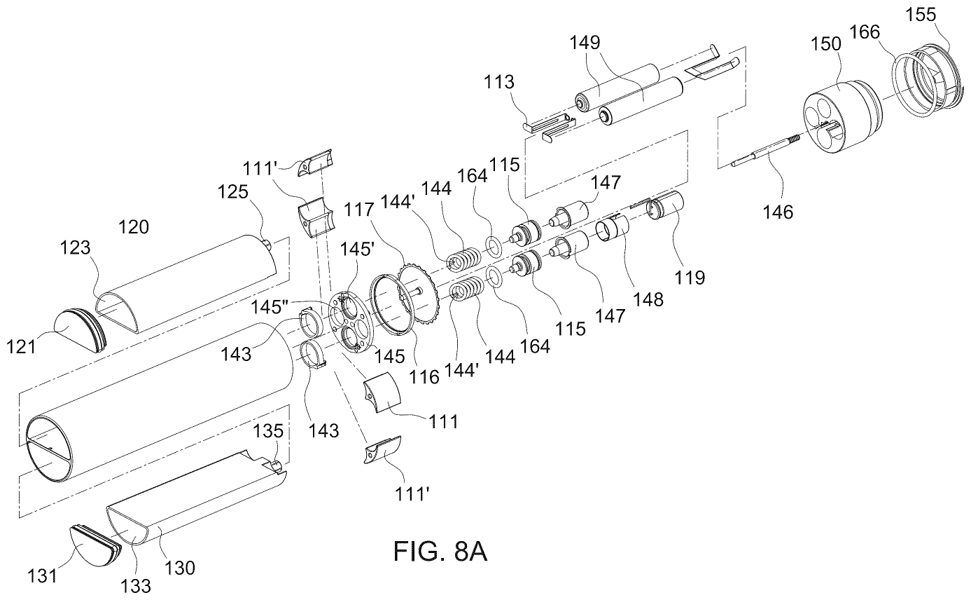

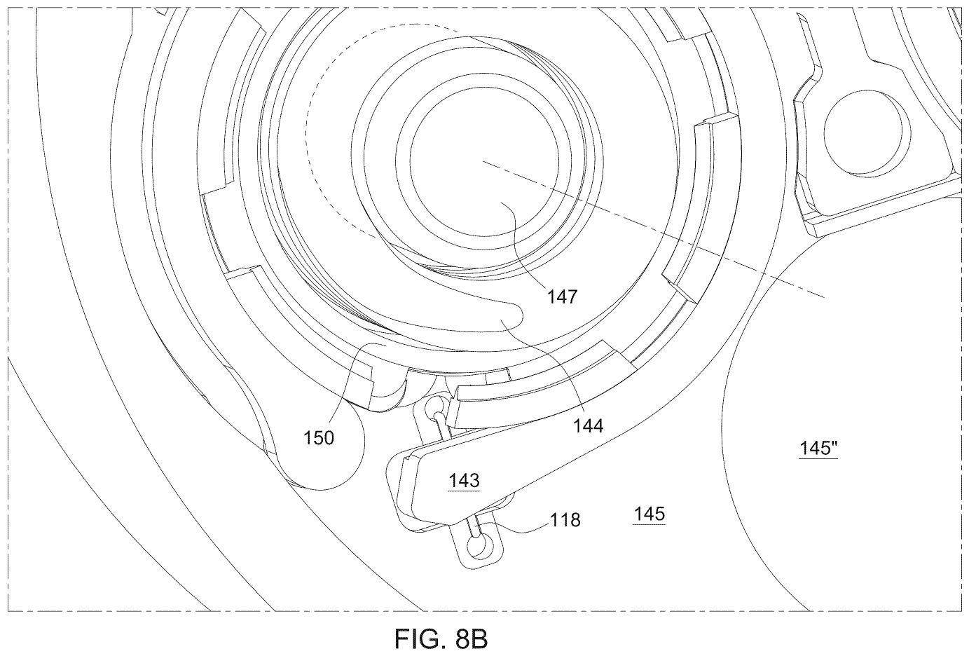

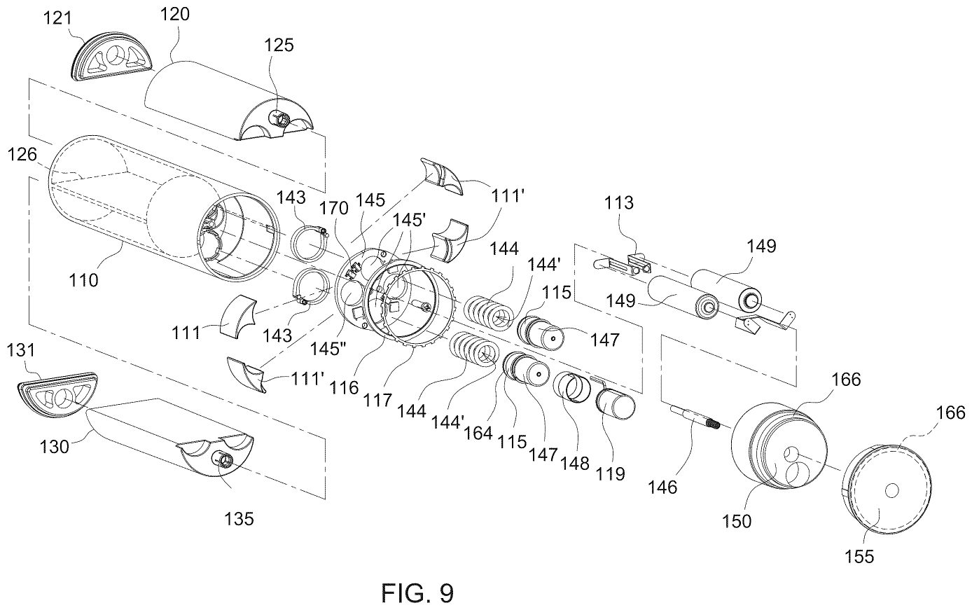

The electronic assembly 145 comprises at least one chamber aperture therethrough for each of the one or more chambers and at least one power aperture for each of one or more power sources. Referring to FIGS. 8A-8B and 9, in one embodiment, the electronic assembly 145 includes a chamber aperture 145′ for each of chambers 120 and 130. The electronic assembly 145 further includes a chamber aperture 145″ for each power source 149.

The at least one power source 149 is disposed between the one or more chambers 120, 130, and a second body end 114 of the casing body 110. Electrical connections (terminals) for the power source may be mounted in the casing body 110, such as on the respective chambers 120, 130, and in the shaped holder 150. In one embodiment, a terminal 113 is shown in FIG. 7.

The spring assembly 141 is disposed through the electronic assembly 145. The spring assembly 141 includes a spring 144 defining a gap 144′ therein, a spring mount 147, a clamping ring 143 disposed around a portion of the spring 144 and adapted to hold the spring 144 in a compressed state, and a heating element 118, coupled to the clamping ring. In one embodiment, an optional pin (not shown) may be used for sealing the clamping ring. If present the heating element 118 may be coupled to the pin or both the pin and clamping ring 143.

Referring to FIGS. 2, 5, and 7, a spring 144 defined a gap 144′ therein. The spring may be any suitable spring in the art. In the illustrated device in the figures, spring 144 is shown as a helical spring. The spring 144 may be disposed around a spring mount 147 disposed inside at least a portion of the gap 144′. The spring mount may be a metal, a plastic material, or both. FIG. 2 illustrates the spring 144 is a compressed state, and FIG. 5 illustrates the spring in a non-compressed state, such as after a release from the clamp. A spring mount 147 is disposed inside at least a portion of the gap 144′ and is disposed spaced from the driver 115.

Under mechanical operation, the spring 144 decompresses and pushes the driver 115 forward. The driver 115 in the driver recess 125 of a chamber 120 moves the chamber 120 in the casing body 110 and ejects the stopper 121. The now open-ended chamber 120 may dispense any chemical material contained therein. FIG. 2 illustrates the spring 144 is a compressed state with the stopper in the sealing position, and FIG. 5 illustrates the spring in a non-compressed state, such as after a release from the clamp, with the chamber 120 moved and the stopper 121 ejected from the chamber 120.

A clamping ring 143 is disposed around a portion of the spring 144 and is adapted to hold the spring 144 on the spring mount 147 in a compressed state.

The clamping ring 143 may be sealed by a number of sealing mechanisms. In one embodiment, a heating element 118 seals the clamping ring 143. In another embodiment, a pin seals the clamping ring. In a further embodiment, the pin seals the clamping ring 143 and is coupled to a heating element 118 that is disposed adjacent to and contacting the pin or is included with the pin in sealing the clamping ring 143. The heating element 118 may include a nichrome material, such as a nichrome wire. The nichrome wire is an alloy of nickel and chromium with high resistance to heat and corrosion, and suitable for use a heating element. The heating element 118 may also be designed to fracture when heated. The pin is preferably made of a plastic that is capable of deforming or fracturing under applied heat.

Referring to FIG. 8B, the heating element 118 is shown sealing the clamping ring 143 according to one embodiment.

In one embodiment, a capacitor holder 148 is disposed adjacent a spring mount 147 in the ejection device assembly 140. A capacitor 119 is disposed in the capacitor holder 148. The heating element 118 is coupled to the capacitor 119 and adapted to integrate into the electronic assembly 145 in a manner as to effectuate the release of the clamping ring 143 as described herein.

The spring assembly 141 and the ejection device assembly 140 are secured to the casing body 110 by the use of the mount 146. The mount 146 is positioned in the casing body using an aperture formed in the casing body support 161 and/or the chamber separator 126. One end of the mount 146 may include a securing surface, such as threaded screw surface for coupling with the shaped holder 150. The electronic assembly 145 may be positioned on the mount 146 with a mount aperture 146′ formed in the electronic assembly 145. A support ring 116 may be coupled to the electronic assembly 145 for supporting and positioning the electronic assembly 145 in the casing body 110. The mount may also be coupled to the shaped holder 150.

The components of the ejection device assembly 140 are disposed in a shaped holder 150. The shaped holder 150 is configured to hold components, such as the spring assembly 141, of the ejection device assembly 140. The shaped holder 150 may be made of a transparent or translucent material, such as a plastic material. A locking ring 117 may be coupled to the support ring 116 on the shaped holder 150 side of the support ring 116 for positioning within the shaped holder 150.

A protective seal 155 is disposed on and around a portion of the shaped holder 150 to seal the second body end 114 of the casing body 110. The protective seal 155 may be configured to cap or be screwed onto the shaped holder 150. The protective seal prevents fluids, such as air and water from entering the casing body 110. The protective seal 155 may be made of a metal or a plastic material. If a plastic material, the plastic material may be a transparent or translucent material. The protecting seal 155 may have grooves 155′ for receiving a support o-ring 166. The support o-ring 166 may be disposed between the casing body 110 and the protective seal 155. The support o-ring 166 may be used with the protective seal 155 to seal the device 100 from fluids.

Electrical devices 170 may be mounted in the ejection device assembly 140, such as on the electronic assembly 145. Suitable electrical devices include a microcontroller, a magnetic switch, a field effect transistor (FET), wireless communication components, LEDs, radio-frequency (RF) devices, resistors, timing crystals, capacitors, a heating element assembly, and sensors, and combinations thereof, among others.

In one embodiment, a microcontroller is disposed in the ejection device assembly 140 and coupled to the capacitor 119 and is electrically coupled to the one of the one or more power sources 149.

In one embodiment, a field effect transistor (FET) is disposed in the ejection device assembly 140 and coupled to the capacitor 119 and is electrically coupled to the one of the one or more power sources 149 and the microcontroller.

In one embodiment, a magnetic switch is disposed in the ejection device assembly 140 and coupled to the microcontroller. In one embodiment, the magnetic switch comprises a tunneling magnetoresistance effect (TMR) sensor switch to activate the device and is configured to start electronic timing circuitry on the microcontroller.

In one embodiment, a light-emitting diode (LED) is disposed in the ejection device assembly 140 and is electrically coupled to the one of the one or more power sources 149 and the microcontroller. The LED provides feedback when the device is activated. The LED is preferably positioned to be seen through the shaped holder 150 and/or protective seal 155.

In another embodiment, a radio-frequency (RF) device is disposed in the ejection device assembly 140 and is electrically coupled to the one of the one or more power sources 149 and the microcontroller and/or LED. In one embodiment, the RF device is a passive RF tag, such as an NFC tag (no batteries). The RF device can be used as an ID tag that will store information such as a unique ID, Product ID, Information on how many dispenses are on the device, timing interval information and active ingredient information.

In another embodiment, a sensor is disposed in the ejection device assembly 140 and is electrically coupled to the one of the one or more power sources 149 and the microcontroller and/or LED. The sensor may be configured to detect a state or action, to prevent the device from dispensing a chemical material prematurely, or to detect a state or action, to release a chemical material.

In one embodiment, the electrical devices 170 include a LED, a TMR switch, a FET for each heating element assembly, a microcontroller, resistors, timing crystal, a capacitor, and one or more heating element assemblies.

Embodiments of the present disclosure may include a wireless connection to the device for remote activation and/or treatment status. In one embodiment, the device includes a wireless connection component disposed in or on the casing body.

In one embodiment of operation, the method includes the following steps. The device is loaded by loading chemicals in the chambers, loading the chambers into the casing, and sealing the chambers with stoppers. The spring assembly is assembled to provide the spring under compression. The spring assembly is loaded into the device, and the proper electrical connections are established. The power supplies are provided to the device and the device is sealed and may be operational. Once sealed the device may be placed in an environment, such as a liquid environment.

Once in position, the device may be activated to eject the stopper and release any chemical material stored in one or more chambers. In one embodiment, the activation may include applying power to the heating element and releasing the clamping ring (by the methods described herein), decompressing the spring, contacting the second end of one of the one or more chambers with the spring, and ejecting the stopper from the first end of the one of the one or more chambers.

The device may be activated manually, timer, or by remote. In one embodiment, the device is activated using a wireless process. In another embodiment, the device is activated by a timer in the microprocessor (and the PCB circuitry) to allow timely dispersion of chemical materials without human interaction.

In another embodiment of operation, the spring is generally compressed during assembly, locked in place with a clamping ring and spring mount which is held closed (clamped) with a heating element, such as a nichrome wire or plastic pin. In some embodiments, the nichrome wire may be from 2 to 4 mm. When ready to release a spring (and fire a dose of medicine), the electronic circuitry charges a desired voltage, such as 3 volts, 4.5 volt, or 6 volts, to have a desired electrical capacitance, such as 1 Farad, 2 Farad or 2.5 Farad capacitor and once the capacitor is charged, the charge is released through a FET which activates the heating element, such as burning the nichrome wire like a fuse. When the nichrome fuse wire burns, the nichrome wire will break and in turn releases the clamping ring, releasing the piston/spring which pushes on the chamber ultimately ejecting the stopper. As an additional benefit, the nichrome wire can also heat up so quickly that the wire can melt the plastic on the clamping ring which also releases the clamping ring. This beneficially provides two ways to release the clamping ring in case the nichrome fuse does not occur, the melting of the plastic will also release the load.

Embodiments of the present disclosure include intricate design features for the purpose of making the device as small as possible, having maximum protection against leakage of ruminal fluid into the internal parts of the bolus and to make the device manufacturable.

Embodiments of the present disclosure may be used to dose animals with chemical materials including, and not limited to, oral vaccines, methane reduction compounds, and antibiotics, among others. Embodiments of the present disclosure may also be used for delivering slow-release large pills into cattle to reduce methane. Embodiments of the present disclosure may also be used to deliver vaccine boosters, for example at 28 days and six months. For example, embodiments of the present disclosure may be used to deliver booster doses of oral vaccines for any of a number of illnesses or conditions.

Embodiments of the present disclosure may include preloaded chambers or may include manufactured and supplied unloaded chamber void of any chemical materials, such as medicine. When unloaded, a producer would “load” the device with desired chemical materials, such as medicine.

Embodiments of the present disclosure may be disposed subcutaneously within the ruminant animal. Embodiments of the present disclosure may include a very small cylindrical implant that releases one or two treatments. For example, embodiments of the present disclosure may include a cylindrical device that is approximately 6 mm diameter and 30 mm in length. Such embodiments may be implanted with the same type of applicator as a cattle hormone implant.

Embodiments of the present disclosure may include the device 100 deployed in the field, either being administered to cattle or deployed in a storm drain catch basin. A permanent magnet (not shown) may be held up to the exterior casing body 110 of the device 100 near the electrical assembly 145 where a TMR magnetic switch is positioned. When the magnet is held in the correct position to trigger the TMR magnetic switch the internal LED will illuminate solid on. For example, when the magnet is held in this position for a period of three (or five) seconds the LED flashes, such as five times. Once the LED flashes five times the timing circuitry is activated on the microcontroller and electrical assembly 145. If the device 100 is factory programmed to release one chamber every 30 days, for example, the device 100 will count for the first 30 day period. At 30 days the electrical assembly 145 will initiate the release of the first chamber, such as chamber 120, by slowly charging the capacitor 119, for example, from about 3 to about 5 minutes. At the end of this charge cycle the capacitor 119 is instantly discharged via a FET which forces the current to flow from the charged capacitor 119 through the heating element 118, such as a nichrome wire, which in turn either fractures the heating element 118, or heats the heating element 118 sufficiently, such as heat deformation, to result in releasing the spring assembly. After this event the timing circuitry will begin timing for the second 30 day period, and continue doing so until all chambers are released.

It is believed that using our device, chemical and pharmaceutical manufacturers can effectively increase the duration of efficacy of their active ingredient or chemical without having to create new formulations and obtain new EPA and/or FDA approvals. For example, some products have efficacy for 30 days once the product is applied. In order to continue efficacy a person needs to apply follow-up treatments every 30 days. Some companies spend a lot of time and money to develop slow-release alternatives to increase the duration of efficacy for up to 90 days, for example, by using large slow release bricks or tablets. However it is difficult to control the rate of release of active ingredient with these products and the products can also be affected by environmental conditions. Additionally slow-release application of active ingredient is often not the preferred method of treatment. Full dose, periodic treatments are generally preferred.

The present embodiment is believed to increase the duration and/or efficacy of treatment by a multiple of the number of sealed chemical chambers. For example, with two chambers in a device 100, each chamber could be loaded with a treatment having 30 day efficacy. The device can release one compartment every 30 days effectively increasing the duration of efficacy by 2× (multiplied by the number of chemical chambers), or 8× for eight chambers.

In the above description, details are set forth by way of example to facilitate an understanding of the disclosed subject matter. It should be apparent to a person of ordinary skill in the field, however, that the disclosed implementations are exemplary and not exhaustive of all possible implementations. Thus, it should be understood that reference to the described examples is not intended to limit the scope of the disclosure. Any alterations and further modifications to the described devices, instruments, methods, and any further application of the principles of the present disclosure are fully contemplated as would normally occur to one skilled in the art to which the disclosure relates. In particular, it is fully contemplated that the features, components, and/or processes described with respect to one implementation may be combined with the features, components, and/or processes described with respect to other implementations of the present disclosure. As used herein, the term “about” may refer to a +/−10% variation from the nominal value. It is to be understood that such a variation can be included in any value provided herein.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more operations or actions for achieving the described method. The method operations and/or actions may be interchanged with one another without departing from the scope of the claims. In other words, unless a specific order of operations or actions is specified, the order and/or use of specific operations and/or actions may be modified without departing from the scope of the claims.

While the foregoing is directed to embodiments of the present disclosure, other and further embodiments of the disclosure may be devised without departing from the basic scope thereof, and the scope thereof is determined by the claims that follow.

What is claimed is:

1. An apparatus, comprising:
a casing body having a first body end and a second body end;
one or more chambers disposed within a portion of the casing body at a first body end, each of the one or more chambers having a first chamber end disposed in the first body end and a second chamber end comprising a driver recess;
a stopper disposed at each of the first chamber end of the one or more chambers; and
an ejection device assembly disposed in the casing body in the second body end and at the second chamber end of the one or more chambers, wherein each stopper being ejectable under force using the ejection device assembly.

2. The apparatus of claim 1, wherein the ejection device assembly comprises:
an electronic assembly having at least one chamber aperture therethrough for each of the one or more chambers and at least one power aperture for each of one or more power sources;
a spring assembly disposed through each aperture for each of the one or more chambers; and
one or more power sources disposed between the one or more chambers and a second body end of the casing body.

3. The apparatus of claim 1, wherein each spring assembly comprises:
a spring defining a gap therein;
a spring mount disposed inside at least a portion of the gap;
a clamping ring disposed around a portion of the spring, and adapted to hold the spring and piston in a compressed state;
a pin sealing the clamping ring; and
a heating element coupled to the pin.

4. The apparatus of claim 3, further comprising a driver disposed in the driver recess for each of the one or more chambers, the driver mechanically coupled to the spring assembly and the driver is spaced from the spring mount.

5. The apparatus of claim 1, further comprising a FET disposed in ejection device assembly and coupled to power source.

6. The apparatus of claim 1, further comprising a microcontroller disposed in the ejection device assembly.

7. The apparatus of claim 1, further comprising a magnetic switch disposed in the casing body and electronically coupled to a microcontroller.

8. The apparatus of claim 7, wherein the magnetic switch comprises a TMR sensor switch to activate the apparatus and is configured to start electronic timing circuitry on the microcontroller.

9. The apparatus of claim 1, further comprising an LED disposed on the casing body.

10. The apparatus of claim 3, wherein the heating element comprises a nichrome wire.

11. The apparatus of claim 1, further comprising a wireless connection component disposed in or on the casing body.

12. A method for operating an apparatus, comprising:
providing a device comprising a casing body, one or more chambers disposed within a portion of the casing body at a first body end, a stopper mounted on each of the one or more the one or more chambers, and an ejection device assembly comprising a compressed spring, a clamping ring disposed around a compressed spring, and a heating element holding close the clamping ring;
applying a power to the heating element and releasing the clamping ring;
decompressing the compressed spring;
moving one of the one or more chambers with the spring; and
ejecting the stopper from the first chamber end of the one of the one or more chambers.

13. The method of claim 12, wherein decompressing the compressed spring comprises applying power to the heating element and releasing the clamping ring.

14. The method of claim 13, wherein applying power to the heating element comprises charging a capacitor and releasing the charge through a FET to heat the heating element sufficiently to melt the heating element, melt a pin, or break the heating element.

15. The method of claim 12, further comprising activating a magnetic switch to activate the device.

16. The method of claim 15, further comprising starting an electronic timing circuitry on a microcontroller.

17. The method of claim 12, wherein the heating element comprises a nichrome wire.

18. The method of claim 12, further comprising operating the device by a wireless connection.

19. The method of claim 12, further comprising operating the device using a timer controlled by a microprocessor.

20. A ruminant bolus delivery device, comprising:
a cylindrical body; and
one or more chambers within the cylindrical body, each of the one or more chambers containing a stopper at an end thereof, the stopper being ejectable under force using a spring assembly.
